(19) United States
(12) Patent Application Publication
(10) Pub. No.: US 2020/0311154 A1
(43) Pub. Date: Oct. 1, 2020

(54) WEB SERVICE PLATFORM FOR DISTRIBUTED SERVER SYSTEMS

(71) Applicant: Trovata, Inc., San Diego, CA (US)

(72) Inventors: Brett P. Turner, San Diego, CA (US); Joseph Drambarean, San Diego, CA (US); Francisco PerezLeon, San Diego, CA (US); Ryan Voris, San Diego, CA (US); Aqeel Gunja, San Diego, CA (US); Satish Mahalingam, San Francisco, CA (US)

(73) Assignee: Trovata, Inc., San Diego, CA (US)

(21) Appl. No.: 16/875,724

(22) Filed: May 15, 2020

Related U.S. Application Data
(63) Continuation-in-part of application No. 15/828,254, filed on Nov. 30, 2017.
(60) Provisional application No. 62/923,349, filed on Oct. 18, 2019.
(60) Provisional application No. 62/429,002, filed on Dec. 1, 2016.

(51) Int. Cl. G06F 16/951; G06F 16/25; H04L 29/08

(52) U.S. Cl. CPC G06F 16/951; H04L 67/26; G06F 16/258

(57) ABSTRACT

A distributed data communication and transformation system operates a web integration service and a normalizing module on a first side of a de-coupling boundary to generate anchors in a relational database. An indexing module and an outflow engine are operated on a second side of the de-coupling boundary to transform the anchor tags into a search index asynchronously from operation of the web integration service, and the outflow engine operates on the second side of the de-coupling boundary asynchronously from the web integration service to filter outputs of the search index without signaling across the de-coupling boundary.

### CROSS REFERENCE TO RELATED APPLICATIONS

This application claims priority and benefit as a continuation-in-part of U.S. application Ser. No. 15/828,254, filed on Nov. 30, 2017, and application Ser. No. 15/828,254 claims priority under 35 U.S.C. 119(e) to U.S. Provisional application Ser. No. 62/429,002, filed on Dec. 1, 2016, the contents each of which are incorporated herein by reference in their entirety. This application also claims priority and benefit under 35 U.S.C. 119(e) to U.S. Provisional application Ser. No. 62/923,349, filed on Oct. 18, 2019, the contents of which are also incorporated herein by reference in their entirety.

### TECHNICAL FIELD

The subject matter described herein relates to web-based service platforms, and more particularly to a system and method for autonomous and semi-autonomous data flow and transformation from disparate computer server systems to client devices.

### BACKGROUND

Functions performed in enterprise resource tracking, planning, and allocation have many interdependencies and they generally operate separately from one another as the skills required to perform the duties of each function are different. As a result, the systems used by each function, and the many work flows to produce desired results for each, can be disparate and involve manual processes. For example, most companies today still rely heavily on spreadsheets for many core or critical tasks.

Conventional platforms or processes for enterprise resource allocation, and planning generate a forecast, which is what a company estimates as its resource availability in the future, that is derived from various sources and compiled by its staff. This process is labor intensive. Once the data is gathered, it is manually input or imported into spreadsheets (i.e., Microsoft Excel® or Google Sheets®, or the like), often within a model that is manually created, configured and maintained. A considerable amount of effort and analysis is often required and expended in computing the forecast using a spreadsheet. Once the forecast is determined, it then must be output to certain reports and communicated to managers for review and decision making.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a distributed computing platform 100 in accordance with one embodiment.

FIG. 2 depicts a controller configuration system 200 in accordance with one embodiment.

FIG. 3 depicts inter-system connection scheduler logic 300 in accordance with one embodiment.

FIG. 4 depicts connection cadence setting logic 400 in accordance with one embodiment.

FIG. 5 depicts hot connection logic 500 in accordance with one embodiment.

FIG. 6 depicts a client server network configuration 600 in accordance with one embodiment.

FIG. 7 depicts a machine 700 in the form of a computer system within which a set of instructions may be executed for causing the machine to perform any one or more of the methodologies discussed herein, according to an example embodiment.

### DETAILED DESCRIPTION

The following description uses certain terminology that should be understood as follows, unless the context indicates another meaning.

“Service” refers to a process configurable with one or more associated policies for use of the process. Services are commonly invoked on server devices by client devices, usually over a machine communication network such as the Internet. Many instances of a service may execute as different processes, each configured with a different or the same policies, each for a different client. “Disparate computer server systems” refers to physically distinct and separate computer systems operated by distinct and separate companies and accessible over distinct and separate communication channels from one another. “Process” refers to software that is in the process of being executed on a device.

“Ingest module” refers to logic that opens and operates communication sessions to pull data from disparate computer server systems. “Outflow module” refers to logic that services on-demand or scheduled requests for structured data for utilization by client apps and applications to generate structured user interfaces and graphical visualizations. “User” refers to a human operator of a client device. The ingest module may include a connection scheduler, a web integration service, and a normalizing module. “Connection scheduler” refers to logic that establishes connections between disparate computer server systems according to a connection cadence determined by cadence rules. “Web integration service” refers to a container for a web service, providing an API between the web service and external logic. “Normalizing module” refers to logic that transforms data received from disparate computer server systems in various and different formats into a common format. “Connection cadence” refers to the rate and/or frequency of connection establishment for data transfers between disparate computer server systems. “Cadence rule” refers to a logic setting that controls a rate and/or frequency of connection establishment and data transfers between disparate computer server systems. “Web service” refers to a service that listens for requests (typically at a particular network port) and provides functionality (e.g., Javascript, algorithms, procedures) and/or data (e.g., HTML, JSON, XML) in response to the requests.

“Hot connection module” refers to logic that maintains a communication session open across configured timeout conditions. “Metadata control settings” refers to settings that control the establishment of secure connections between disparate computer server systems. “Indexing module” refers to logic that transforms received data signals into a searchable index. “Arbitrator” refers to logic that manages contention for a shared computing, communication, or memory resource in a computer system. “Outflow engine” refers to engine logic utilized by the outflow module, where an engine is a logic component optimized to move and/or transform data according to specific algorithms with high performance.

Embodiments of a distributed computing platform are disclosed to seamlessly automate operational tasks across functional areas within an enterprise. The platform implements a scalable online system for data ingest, indexing, and outflow, with performance-enhancing rate matching between each stage.

The disclosed system may be configured with named hierarchical filters. As new transactions occur, indexing is applied across a decoupling boundary, and hierarchical filters (called ‘tags’) are applied post-index for enhanced performance and customization without necessitating the instrumentation of each transaction.

Conventional indexing approaches write fields into each transaction that matches a condition (a ‘tag’). “Tag” refers to a label associated with a filter condition. An example of a filter condition is a Structured Query Language or Boolean logic setting. An example of a tag (the format is just an example) is: September Large Transactions->“amount >$100 AND 9/1/2019<=date <=9/30/2019”. This degrades performance as edits or changes to the tag or any aspect of the parameters utilized by the tag require the system to scan through the entirety of the index and make changes to each record utilizing the tag, and then re-index.

The disclosed system exhibits improved performance by de-coupling indexing from the parametric constraints of tagging and thus may better match indexing performance with a rate of data ingest and/or data outflow.

Multilevel hierarchical tags may be configured so that a parent-child relationship is established through the application of iterative refinements.

The indexing operates asynchronously from the data ingest across a decoupling boundary. When ingestion and normalization complete a push notification may be applied across the decoupling boundary to trigger operation of the indexing module to update the search index based on anchor tags in relational tables of the normalized data set.

The system enables on-demand retrieval by client devices of highly customized information for use in analytics, forecasting, and reporting, based on recently and periodically acquired data sets from disparate computer server systems with improved performance and lower latency than is available with conventional approaches.

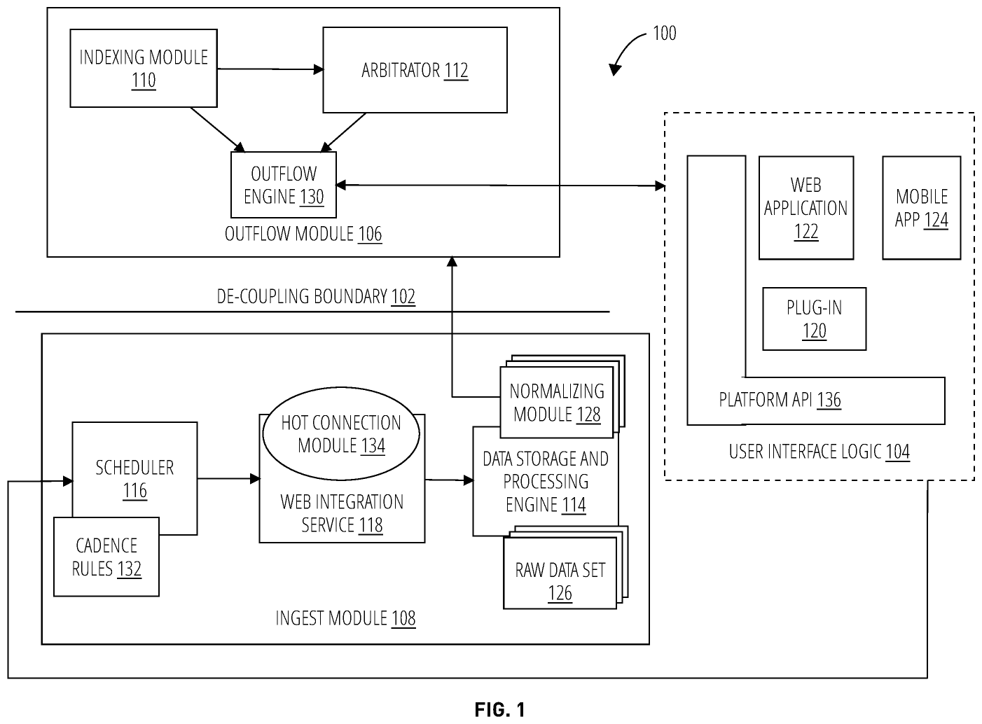

FIG. 1 depicts a distributed computing platform 100 in one embodiment. At a high level, the distributed computing platform 100 comprises an ingest module 108 and an outflow module 106 that interoperate across a de-coupling boundary 102. The ingest module 108 and outflow module 106 exchange data and control signals with user interface logic 104.

The ingest module 108 is operatively coupled to the user interface logic 104 and activates on a schedule to pull data from disparate computer server systems. The ingest module 108 is operatively coupled to the outflow module 106 and passes normalized data across the de-coupling boundary 102 to the outflow module 106. The outflow module 106 is communicatively coupled to the user interface logic 104 allowing a user to instrument a pipeline of normalized data from the ingest module 108 to the outflow module 106 and from there to the user interface logic 104 using hierarchical filter control settings, referred to herein as ‘tags’.

The user interface logic 104 depicted here includes one or more of a mobile application 124, a web application 122, and a plug-in 120. The mobile application 124 and the web application 122 enable user interaction with and configuration of the distributed computing platform 100. The plug-in 120 provides an interface between a restful logic component such as Excel and the distributed computing platform 100.

More generally, the user interface logic 104 may be implemented via a platform application program interface (e.g., platform API 136), which may provide functions, configuration settings, and other logic to configure and control components of the ingest module 108 and outflow module 106. The platform API 136 provides a mechanism to extend the capability to interact with the distributed computing platform 100 to any number of possible implementations (mobile application 124, web application 122, etc.)

The ingest module 108 comprises a scheduler 116, a web integration service 118, and a data storage and processing engine 114. The ingest module 108 is a serverless implementation that activates and deactivates services dynamically to ingest raw data from disparate computer server systems into a normalized format, according to individual schedules for each of the disparate computer server systems. “Serverless” refers to a computing system architected such that performance scalability is enabled by configuring, either automatically or via manually configured control settings, units of resource consumption (e.g., computational units, communication bandwidth, memory) rather than by adding or removing entire computer servers. Data ingest is controlled by a scheduler 116 and cadence rules 132. The scheduler 116 utilizes the cadence rules 132 to operate the web integration service 118, which opens connections and pulls data for further processing by the data storage and processing engine 114.

A hot connection module 134 manages the connections utilized by the web integration service 118 to pull data from the disparate computer server systems. The web integration service 118 invokes a dynamic application program interface (API) to each of the disparate computer server systems; each API may be specific to a particular server system and the connection via the API is controlled and maintained by the hot connection module 134.

The data storage and processing engine 114 operates a normalizing module 128 on a raw data set 126 received from the web integration service 118. This results in a normalized data set with consistent fields regardless of the specific format of the raw data sets from different ones of the disparate computer server systems. The normalizing module 128 utilizes a dynamically activated set of algorithms specific to the format of the data source. These algorithms perform functions such as file conversion, parsing, and analysis, and are well known in the art.

The connections established and maintained by the hot connection module 134 are “hot connections” that are opened and closed dynamically such that the connection is made persistent per rules established by institution-specific security protocols—OAuTH, tokenized, dual authentication etc. These rules may be configured in the hot connection module 134 or the scheduler 116 or both.

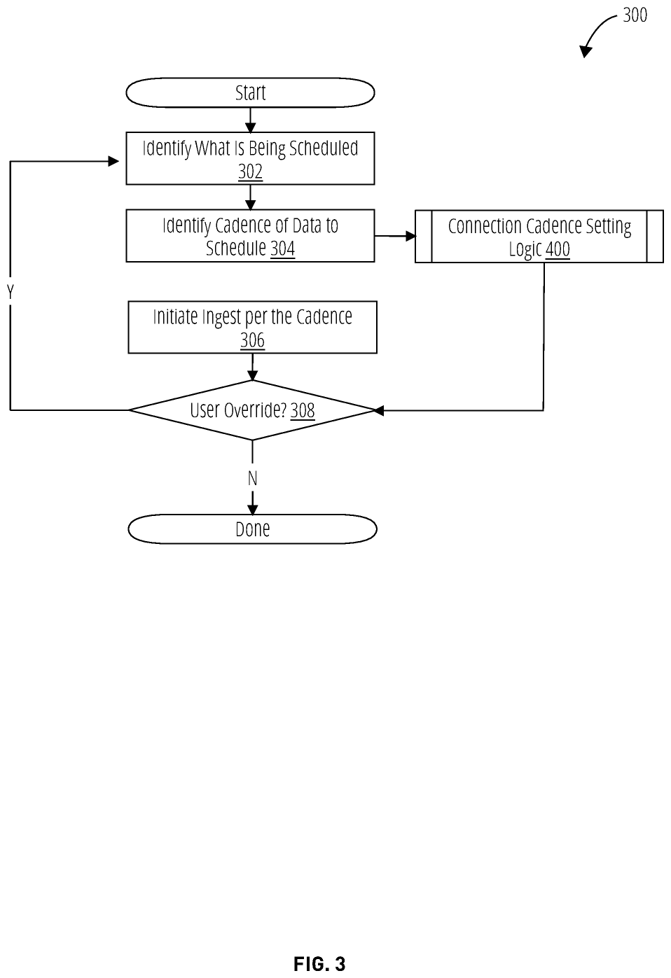

The scheduler 116 acts as a throttle/rate limiter based on a hierarchical prioritization of at least the following parameters (see FIG. 3):
1. institution restrictions on data access (connections or data amounts) per time interval
2. data availability or update schedules
3. user access privileges for the institution (what data are they allowed access to and how often)
4. institutional limits on data transfer amounts/rates per session

Normalized data is communicated from the ingest module 108 to the outflow module 106 across the de-coupling boundary 102. The de-coupling boundary 102 is a computer resource utilization boundary separating the operation of the ingest module 108 and the outflow module 106. The de-coupling boundary 102 enables the ingest module 108 to operate independently and at a different rate from the outflow module 106; particularly the indexing module 110 of the outflow module 106 may operate asynchronously from the ingest and normalization of data by the ingest module 108.

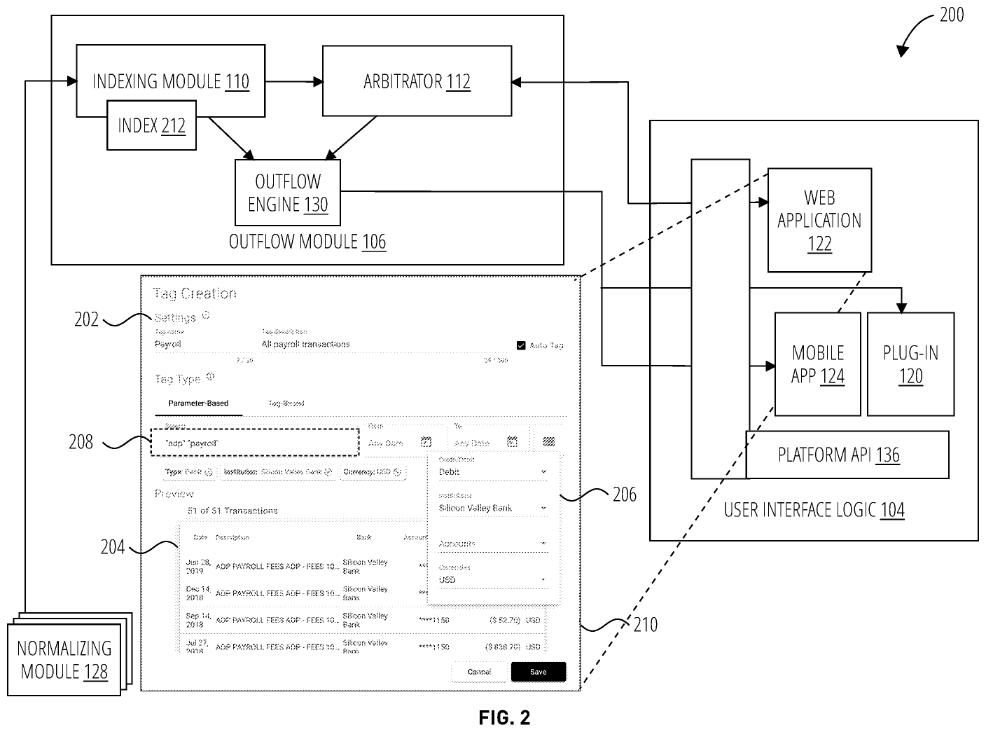

The outflow module 106 comprises an arbitrator 112, an indexing module 110, and an outflow engine 130. The outflow module 106 is a serverless implementation for data delivery for which services are activated and deactivated dynamically per client. The indexing module 110 is operatively coupled to the arbitrator 112 which manages contention for the outflow engine 130 among the various clients requesting data via the user interface logic 104. The arbitrator 112 also controls the operation of the outflow engine 130 based on hierarchical filters configured via the web application 122, as depicted in FIG. 2.

The distributed computing platform 100 may, in one embodiment, operate according to the processes depicted in FIG. 3 through FIG. 5.

FIG. 2 depicts a controller configuration system 200 in one embodiment. The controller configuration system 200 as depicted includes some components of the distributed computing platform 100 depicted in FIG. 1 but also includes additional aspects. The web application 122 is depicted in more detail and comprises tagging logic 210 that provides a tag descriptor setting 202, tag parameters 208, metadata 206, and a dynamic preview window 204.

The tagging logic 210 enables the configuration of tags comprising filter settings. The tag descriptor setting 202 is a label to concisely reference the tag for future use. The tag parameters 208 along with the metadata 206 form filter settings to apply to the normalized data generated by the ingest module. The metadata 206 may identify specific institutions, accounts, currencies, and/or transaction types. Other types of metadata 206 may also be selectable. The dynamic preview window 204 displays normalized data that would be associated with the tag as it is currently configured. To form a hierarchical filter, one or more tag descriptor setting 202 for existing tags may be set in the tag parameters 208. The tag parameters 208 may be generated in many ways, including explicit selections, search queries, and natural language inputs. The tag parameters 208 may be applied as “fuzzy” parameters as that term is normally understood in the art. Some of the tag parameters 208, such as the institutions and accounts, may be “anchor” settings that associate with specific records in one or more database comprising the normalized data.

Substantial performance improvements are realized by building the search index 212 based on relational tables in the normalized data set that includes fields for the anchor tag parameters 208, and then filtering search results generated from the index 212 for tag parameters 208 that are not anchored but instead implemented as filter restrictions applied to the outflow engine 130. The filter restrictions applied to the outflow engine 130 based on tag parameters 208 are formed dynamically (as client requests are received). The tag parameters 208 that are applied as filter settings may for example implement white list and black list conditions on the data communicated by the outflow engine 130.

The indexing module 110 is asynchronously coupled to the normalizing module 128 to receive the normalized data. The web application 122 is communicatively coupled to the arbitrator 112 to configure the arbitrator 112 with one or more configured tag for the outflow engine 130 to apply to the index 212 generated by the indexing module 110. The outflow engine 130 is operatively coupled to communicate the filtered data sets thus generated to the mobile application 124 and/or the plug-in 120 (for example).

The controller configuration system 200 may in one embodiment operate according to the process depicted in FIG. 3 through FIG. 5.

FIG. 3 depicts an inter-system connection scheduler logic 300 in one embodiment. The inter-system connection scheduler logic 300 may be implemented for example in the scheduler 116. The actions depicted should not be presumed to occur in the order presented, unless an action depends on the result of a previous action to be carried out. If two or more actions are not conditioned on one another in some way, one skilled in the art will readily ascertain that they may be carried out in parallel, in a time-division fashion, or in a different order.

At block 302, the inter-system connection scheduler logic 300 identifies which data sources are being scheduled. This action may be carried out for example by the scheduler 116 by way of the user interface logic 104. This action may result in the identification of data to pull and from which of the disparate computer server systems that act as data sources.

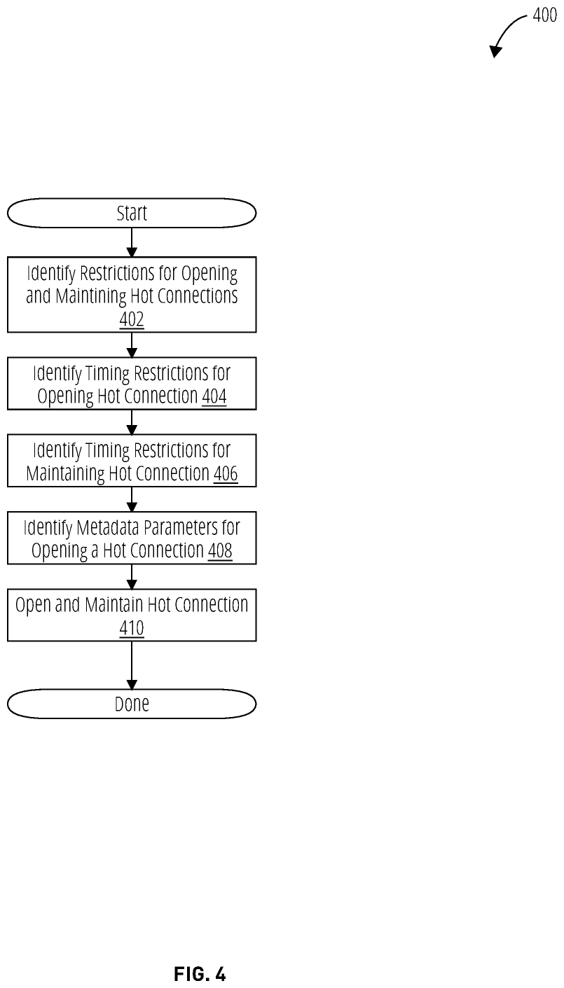

At block 304, the inter-system connection scheduler logic 300 identifies the cadence of the scheduled data. This action may be carried out by the scheduler 116 and may be embodied in the cadence rules 132. This action may result in invocation of a connection cadence setting logic 400 as depicted in more detail in FIG. 4.

At block 306, the inter-system connection scheduler logic 300 initiates ingest of data as per the cadence rules 132. This action may be carried out by the web integration service 118 by way of the hot connection module 134. This action may result in data being pulled and stored from various banking of the disparate computer server systems through dynamic API connections managed by the hot connection module 134 according the scheduler 116 and the cadence rules 132.

At decision block 308, the inter-system connection scheduler logic 300 carries out a determination for the presences of a user override received from the connection cadence setting logic 400. “User override” refers to a control setting by a user that preempts or replaces a system setting. This test may be carried out by the scheduler 116 and the cadence rules 132. This determination results in identification of a user override or the absence of the user override. If a user override is detected, the inter-system connection scheduler logic 300 returns to the block 302 where the inter-system connection scheduler logic 300 beings again by identifying the data to schedule. If a user override is not detected the process terminates. A user override may originate from a number of sources such as a system operator of the distributed computing platform 100, or a user of client logic such as the user interface logic 104.

FIG. 4 depicts connection cadence setting logic 400 in one embodiment. The connection cadence setting logic 400 may be operated to set cadence for pulling data from disparate computer server systems in accordance with their access and security protocols. The actions depicted should not be presumed to occur in the order presented, unless an action depends on the result of a previous action to be carried out. If two or more actions are not conditioned on one another in some way, one skilled in the art will readily ascertain that they may be carried out in parallel, in a time-division fashion, or in a different order.

At block 402, the connection cadence setting logic 400 identifies availability restrictions for establishing the hot connections. This action may be carried out in accordance with the cadence rules 132 by hot connection module 134. This action results in the identification of data access availability.

At block 404, the connection cadence setting logic 400 identifies timing restrictions for opening hot connections and again is implemented by the hot connection module 134 in accordance with the cadence rules 132. This action results in the identification of timing restrictions such as required intervals between connections or permissible or blackout connection times for institution-specific security protocols—OATH, tokenized, dual authentication etc.

At block 406, the connection cadence setting logic 400 identifies timing restrictions for maintaining hot connections and again is implemented by the hot connection module 134 in accordance with the cadence rules 132. This action results in the identification of timing restrictions such as timeout intervals and restrictions on connection duration for institution-specific security protocols—OAuTH, tokenized, dual authentication etc.

At block 408, the connection cadence setting logic 400 (e.g., the hot connection module 134) identifies metadata parameters for opening and establishing a hot connection. This action results in the identification of connection protocol and API-specific parameters, including authentication and authorization parameters, for opening and maintaining a hot connection.

Following block 408, the connection cadence setting logic 400 moves to block 410 where the connection is established and maintained by the hot connection module 134 and scheduled data pulls are made from the disparate computer server systems.

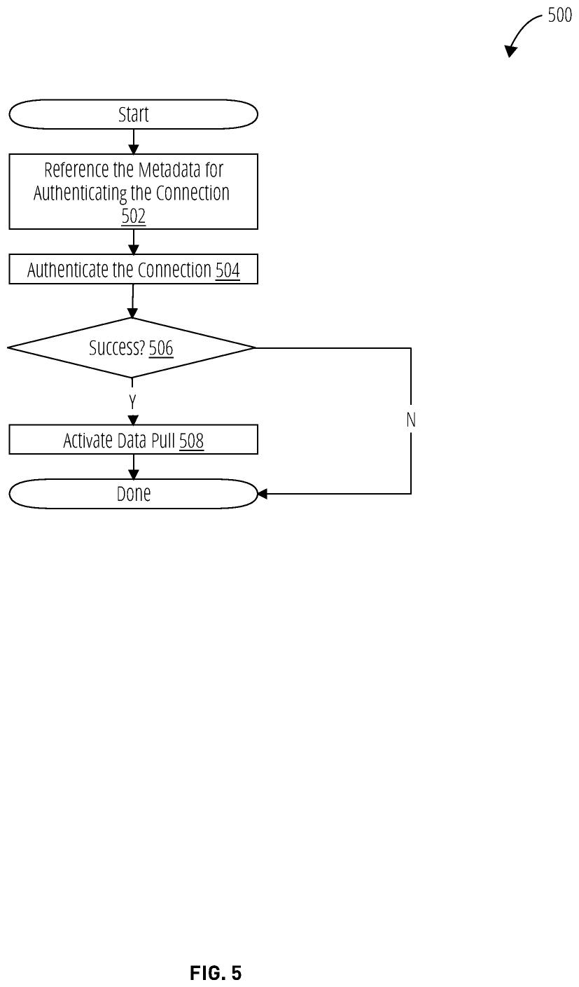

FIG. 5 depicts hot connection logic 500 in one embodiment. The hot connection logic 500 establishes and maintains hot connections with external disparate computer server systems. The actions depicted should not be presumed to occur in the order presented, unless an action depends on the result of a previous action to be carried out. If two or more actions are not conditioned on one another in some way, one skilled in the art will readily ascertain that they may be carried out in parallel, in a time-division fashion, or in a different order.

At block 502, the hot connection logic 500 references the connection type and API metadata to begin authentication and authorization with one of the disparate computer server systems. This action and subsequent ones of the hot connection logic 500 would typically be carried out by the hot connection module 134 in accordance with the cadence rules 132. At block 504, the hot connection logic 500 utilizes the metadata to authenticate/authorize and establish a connection with the external system.

At decision block 506, the hot connection logic 500 determines whether the connection was successfully established. If the determination identifies that the connection was successful, the hot connection logic 500 moves to block 508 where the data pull is activated. If the connection was not successful, the process either terminates or retries the establishment of the connection.

Software Implementations

This disclosure uses various terms known in the software and computer arts and which should be understood as follows. “Logic” refers to any set of one or more components configured to implement functionality in a machine. Logic includes machine memories configured with instructions that when executed by a machine processor cause the machine to carry out specified functionality; discrete or integrated circuits configured to carry out the specified functionality; and machine/device/computer storage media configured with instructions that when executed by a machine processor cause the machine to carry out specified functionality. Logic specifically excludes software per se, signal media, and transmission media. “Instructions” refers to symbols representing commands for execution by a device using a processor, microprocessor, controller, interpreter, or other programmable logic. Broadly, ‘instructions’ can mean source code, object code, and executable code. ‘instructions’ herein is also meant to include commands embodied in programmable read-only memories (EPROM) or hard coded into hardware (e.g., ‘micro-code’) and like implementations wherein the instructions are configured into a machine memory or other hardware component at manufacturing time of a device.

“Software” refers to logic implemented as instructions for controlling a programmable device or component of a device (e.g., a programmable processor, controller). Software can be source code, object code, executable code, machine language code. Unless otherwise indicated by context, software shall be understood to mean the embodiment of said code in a machine memory or hardware component, including “firmware” and micro-code. “Interpreter” refers to an interpreter is logic that directly executes instructions written in a source code scripting language, without requiring the instructions to a priori be compiled into machine language. An interpreter translates the instructions into another form, for example into machine language, or into calls to internal functions and/or calls to functions in other software modules.

“Source code” refers to a high-level textual computer language that requires either interpretation or compilation in order to be executed by a device. “Object code” refers to the computer code output by a compiler or as an intermediate output of an interpreter. Object code often takes the form of machine language or an intermediate language such as register transfer language (RTL). “Executable code” refers to instructions in a ready-to-execute form by a programmable device. For example, source code instructions in non-interpreted execution environments are not executable code because they must usually first undergo compilation, linking, and loading by the operating system before they have the proper form for execution. Interpreted computer code may be considered executable code because it can be directly applied to a programmable device (an interpreter) for execution, even though the interpreter itself may further transform the interpreted computer code into machine language instructions.

“Programmable device” refers to any logic (including hardware and software logic) who's operational behavior is configurable with instructions. “Machine language” refers to instructions in a form that is directly executable by a programmable device without further translation by a compiler, interpreter, or assembler. In digital devices, machine language instructions are typically sequences of ones and zeros. “Module” refers to a computer code section having defined entry and exit points. Examples of modules are any software comprising an application program interface, drivers, libraries, functions, and subroutines. “Computer code” refers to any of source code, object code, or executable code. “Compiler” refers to logic that transforms source code from a high-level programming language into object code or in some cases, into executable code.

“Operating system” refers to logic, typically software, that supports a device's basic functions, such as scheduling tasks, managing files, executing applications, and interacting with peripheral devices. In normal parlance, an application is said to execute “above” the operating system, meaning that the operating system is necessary in order to load and execute the application and the application relies on modules of the operating system in most cases, not vice-versa. The operating system also typically intermediates between applications and drivers. Drivers are said to execute “below” the operating system because they intermediate between the operating system and hardware components or peripheral devices. “Interpreted computer code” refers to instructions in a form suitable for execution by an interpreter. “Executable” refers to a file comprising executable code. If the executable code is not interpreted computer code, a loader is typically used to load the executable for execution by a programmable device. “Computer code section” refers to one or more instructions.

“Application program interface” refers to instructions implementing entry points and return values to a module. “Driver” refers to low-level logic, typically software, that controls components of a device. Drivers often control the interface between an operating system or application and input/output components or peripherals of a device, for example.

“Application” refers to any software that is executed on a device above a level of the operating system. An application will typically be loaded by the operating system for execution and will make function calls to the operating system for lower-level services. An application often has a user interface but this is not always the case. Therefore, the term ‘application’ includes background processes that execute at a higher level than the operating system.

“File” refers to a unitary package for storing, retrieving, and communicating data and/or instructions. A file is distinguished from other types of packaging by having associated management metadata utilized by the operating system to identify, characterize, and access the file. “Loader” refers to logic for loading programs and libraries. The loader is typically implemented by the operating system. A typical loader copies an executable into memory and prepares it for execution by performing certain transformations, such as on memory addresses.

The systems disclosed herein, or particular components thereof, may typically be implemented as software comprising instructions executed on one or more programmable device. By way of example, components of the disclosed systems may be implemented as an application, an app, drivers, or services. “App” refers to a type of application with limited functionality, most commonly associated with applications executed on mobile devices. Apps tend to have a more limited feature set and simpler user interface than applications as those terms are commonly understood in the art. In one particular embodiment, the system is implemented as a service that executes as one or more processes, modules, subroutines, or tasks on a server device so as to provide the described capabilities to one or more client devices over a network. “Subroutine” refers to a module configured to perform one or more calculations or other processes. In some contexts the term ‘subroutine’ refers to a module that does not return a value to the logic that invokes it, whereas a ‘function’ returns a value. However herein the term ‘subroutine’ is used synonymously with ‘function’. “Task” refers to one or more operations that a process performs. However the system need not necessarily be accessed over a network and could, in some embodiments, be implemented by one or more app or applications on a single device or distributed between a mobile device and a computer, for example.

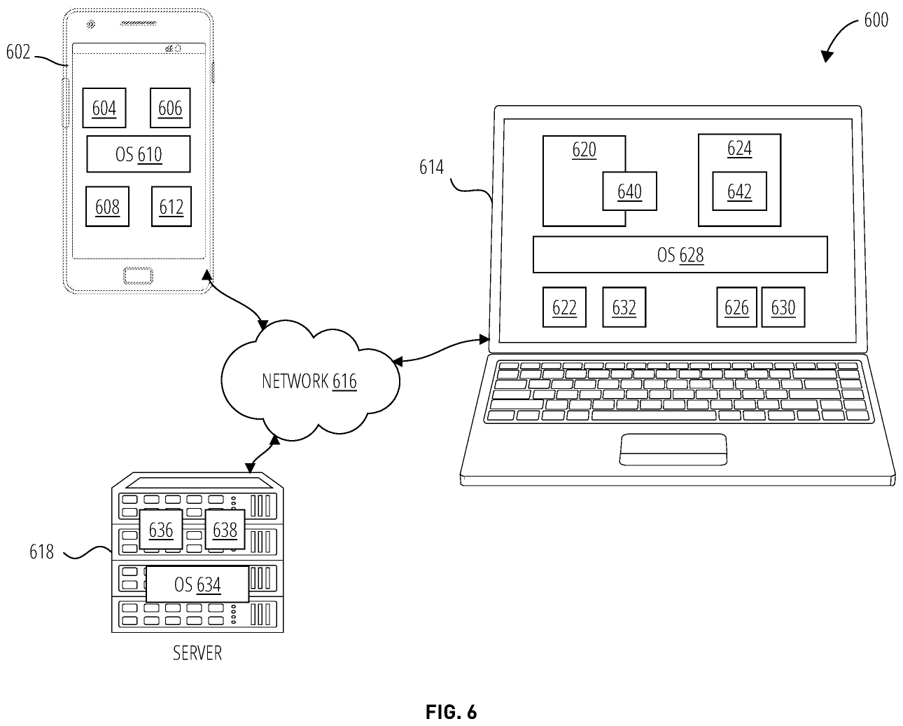

Referring to FIG. 6, a client server network configuration 600 illustrates various computer hardware devices and software modules coupled by a network 616 in one embodiment. Each device includes a native operating system, typically pre-installed on its non-volatile RAM, and a variety of software applications or apps for performing various functions.

The mobile programmable device 602 comprises a native operating system 610 and various apps (e.g., app 604 and app 606), one or more of which may implement the the mobile application 124 (e.g., as a mobile app). A computer 614 also includes an operating system 628 that may include one or more library of native routines to run executable software on that device. “Library” refers to a collection of modules organized such that the functionality of all the modules may be included for use by software using references to the library in source code. The computer 614 also includes various executable applications (e.g., application 620 and application 624). The mobile programmable device 602 and computer 614 are configured as clients on the network 616. A server 618 is also provided and includes an operating system 634 with native routines specific to providing a service (e.g., service 638 and service 636) available to the networked clients in this configuration. As previously noted, various components of the ingest module 108 and/or outflow module 106 may be implemented as such services.

As is well known in the art, an application, an app, or a service may be created by first writing computer code to form a computer program, which typically comprises one or more computer code sections or modules. “Computer program” refers to another term for ‘application’ or ‘app’. Computer code may comprise instructions in many forms, including source code, assembly code, object code, executable code, and machine language. “Assembly code” refers to a low-level source code language comprising a strong correspondence between the source code statements and machine language instructions. Assembly code is converted into executable code by an assembler. The conversion process is referred to as assembly. Assembly language usually has one statement per machine language instruction, but comments and statements that are assembler directives, macros, and symbolic labels may also be supported. Computer programs often implement mathematical functions or algorithms and may implement or utilize one or more application program interfaces. “Algorithm” refers to any set of instructions configured to cause a machine to carry out a particular function or process.

A compiler is typically used to transform source code into object code and thereafter a linker combines object code files into an executable application, recognized by those skilled in the art as an “executable”. “Linker” refers to logic that inputs one or more object code files generated by a compiler or an assembler and combines them into a single executable, library, or other unified object code output. One implementation of a linker directs its output directly to machine memory as executable code (performing the function of a loader as well). The distinct file comprising the executable would then be available for use by the computer 614, mobile programmable device 602, and/or server 618. Any of these devices may employ a loader to place the executable and any associated library in memory for execution. The operating system executes the program by passing control to the loaded program code, creating a task or process. An alternate means of executing an application or app involves the use of an interpreter (e.g., interpreter 642).

In addition to executing applications (“apps”) and services, the operating system is also typically employed to execute drivers to perform common tasks such as connecting to third-party hardware devices (e.g., printers, displays, input devices), storing data, interpreting commands, and extending the capabilities of applications. For example, a driver 608 or driver 612 on the mobile programmable device 602 or computer 614 (e.g., driver 622 and driver 632) might enable wireless headphones to be used for audio output(s) and a camera to be used for video inputs. Any of the devices may read and write data from and to files (e.g., file 626 or file 630) and applications or apps may utilize one or more plug-in (e.g., plug-in 640 which may implement plug-in 120) to extend their capabilities (e.g., to encode or decode video files). “Plug-in” refers to software that adds features to an existing computer program without rebuilding (e.g., changing or re-compiling) the computer program. Plug-ins are commonly used for example with Internet browser applications.

The network 616 in the client server network configuration 600 can be of a type understood by those skilled in the art, including a Local Area Network (LAN), Wide Area Network (WAN), Transmission Communication Protocol/Internet Protocol (TCP/IP) network, and so forth. These protocols used by the network 616 dictate the mechanisms by which data is exchanged between devices.

Machine Embodiments

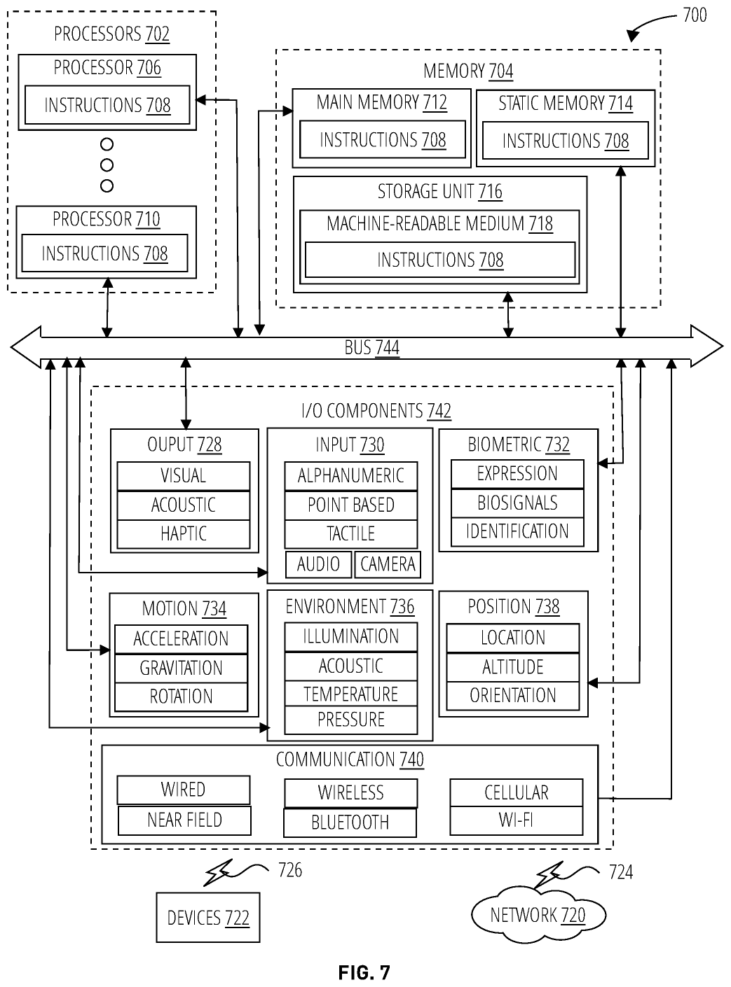

FIG. 7 depicts a diagrammatic representation of a machine 700 in the form of a computer system within which logic may be implemented to cause the machine to perform any one or more of the functions or methods disclosed herein, according to an example embodiment.

Specifically, FIG. 7 depicts a machine 700 comprising instructions 708 (e.g., a program, an application, an applet, an app, or other executable code) for causing the machine 700 to perform any one or more of the functions or methods discussed herein. For example, the instructions 708 may cause the machine 700 to implement the functionality described in conjunction with the distributed computing platform 100, controller configuration system 200, inter-system connection scheduler logic 300, connection cadence setting logic 400, and hot connection logic 500. The instructions 708 configure a general, non-programmed machine into a particular machine 700 programmed to carry out said functions and/or methods.

In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 708, sequentially or otherwise, that specify actions to be taken by the machine 700. Further, while only a single machine 700 is depicted, the term “machine” shall also be taken to include a collection of machines that individually or jointly execute the instructions 708 to perform any one or more of the methodologies or subsets thereof discussed herein.

The machine 700 may include processors 702, memory 704, and I/O components 742, which may be configured to communicate with each other such as via one or more bus 744. In an example embodiment, the processors 702 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, one or more processor (e.g., processor 706 and processor 710) to execute the instructions 708. The term “processor” is intended to include multi-core processors that may comprise two or more independent processors (sometimes referred to as “cores”) that may execute instructions contemporaneously. Although FIG. 7 depicts multiple processors 702, the machine 700 may include a single processor with a single core, a single processor with multiple cores (e.g., a multi-core processor), multiple processors with a single core, multiple processors with multiples cores, or any combination thereof.

The memory 704 may include one or more of a main memory 712, a static memory 714, and a storage unit 716, each accessible to the processors 702 such as via the bus 744. The main memory 712, the static memory 714, and storage unit 716 may be utilized, individually or in combination, to store the instructions 708 embodying any one or more of the functionality described herein. The instructions 708 may reside, completely or partially, within the main memory 712, within the static memory 714, within a machine-readable medium 718 within the storage unit 716, within at least one of the processors 702 (e.g., within the processor's cache memory), or any suitable combination thereof, during execution thereof by the machine 700.

The I/O components 742 may include a wide variety of components to receive input, provide output, produce output, transmit information, exchange information, capture measurements, and so on. The specific I/O components 742 that are included in a particular machine will depend on the type of machine. For example, portable machines such as mobile phones will likely include a touch input device or other such input mechanisms, while a headless server machine will likely not include such a touch input device. It will be appreciated that the I/O components 742 may include many other components that are not shown in FIG. 7. The I/O components 742 are grouped according to functionality merely for simplifying the following discussion and the grouping is in no way limiting. In various example embodiments, the I/O components 742 may include output components 728 and input components 730. The output components 728 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 730 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), one or more cameras for capturing still images and video, and the like.

In further example embodiments, the I/O components 742 may include biometric components 732, motion components 734, environmental components 736, or position components 738, among a wide array of possibilities. For example, the biometric components 732 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 742 may include communication components 740 operable to couple the machine 700 to a network 720 or devices 722 via a coupling 724 and a coupling 726, respectively. For example, the communication components 740 may include a network interface component or another suitable device to interface with the network 720. In further examples, the communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 722 may be another machine or any of a wide variety of peripheral devices (e.g., a peripheral device coupled via a USB).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geolocation, location via Wi-Fi® signal triangulation, location via detecting an NFC beacon signal that may indicate a particular location, and so forth.

Instruction and Data Storage Medium Embodiments

The various memories (i.e., memory 704, main memory 712, static memory 714, and/or memory of the processors 702) and/or storage unit 716 may store one or more sets of instructions and data structures (e.g., software) embodying or utilized by any one or more of the methodologies or functions described herein. These instructions (e.g., the instructions 708), when executed by processors 702, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors and internal or external to computer systems. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such intangible media, at least some of which are covered under the term “signal medium” discussed below.

Communication Network Embodiments

In various example embodiments, one or more portions of the network 720 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 720 or a portion of the network 720 may include a wireless or cellular network, and the coupling 724 may be a Code Division Multiple Access (CDMA) connection, a Global System for Mobile communications (GSM) connection, or another type of cellular or wireless coupling. In this example, the coupling 724 may implement any of a variety of types of data transfer technology, such as Single Carrier Radio Transmission Technology (1×RTT), Evolution-Data Optimized (EVDO) technology, General Packet Radio service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 708 and/or data generated by or received and processed by the instructions 708 may be transmitted or received over the network 720 using a transmission medium via a network interface device (e.g., a network interface component included in the communication components 740) and utilizing any one of a number of well-known transfer protocols (e.g., hypertext transfer protocol (HTTP)). Similarly, the instructions 708 may be transmitted or received using a transmission medium via the coupling 726 (e.g., a peer-to-peer coupling) to the devices 722. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 708 for execution by the machine 700, and/or data generated by execution of the instructions 708, and/or data to be operated on during execution of the instructions 708, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

“Logic” refers to machine memory circuits, non transitory machine readable media, and/or circuitry which by way of its material and/or material-energy configuration comprises control and/or procedural signals (machine-executable “instructions”), and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A distributed data communication and transformation system comprising:
an ingest module operative on a first side of a de-coupling boundary, the ingest module comprising:
a web integration service; and
a normalizing module;
an outflow module operating on a second side of the de-coupling boundary, the outflow module comprising:
an indexing module coupled to transform output of the normalizing module into a search index, the indexing module operative asynchronously from the normalizing module and the web integration service across the de-coupling boundary; and
an outflow engine dynamically configurable from the second side of the de-coupling boundary to filter outputs of the search index without signaling across the de-coupling boundary.

2. The system of claim 1, further comprising:
a hot connection module responsive to a plurality of metadata control settings for disparate computer server systems, the metadata control settings implementing cadence rules for connection to and data transfer from the disparate computer server systems.

3. The system of claim 2, further comprising:
the hot connection module configured to execute a connection cadence on each of the disparate computer server systems based on the cadence rules.

4. The system of claim 2, the cadence rules comprising:
control settings for availability restriction for establishing hot connections;
timing restrictions for opening the hot connections; and
timing restrictions for maintaining the hot connections.

5. The system of claim 1, the normalizing module comprising a plurality of data transformation algorithms to apply to output of the web integration service.

6. The system of claim 1, the outflow module operations on the outputs of the search index controlled by hierarchical filters configurable from user interface logic of client devices.

7. The system of claim 1, the outflow engine responsive to filter settings generated from a web application to the second side of the de-coupling boundary.

8. The system of claim 1, wherein the ingest module and the outflow module are serverless.

9. The system of claim 1, further comprising:
logic to generate a push notification from the first side of the de-coupling boundary to the second side of the de-coupling boundary upon completion of ingest and normalization operations on the first side of the de-coupling boundary.

10. The system of claim 9, further comprising:
the indexing module configured to respond to the push notification to update the search index based on anchor tags in relational tables of a normalized data set on the first side of the de-coupling boundary.

11. A distributed data communication and transformation method comprising:
operating a web integration service and a normalizing module on a first side of a de-coupling boundary to generate anchors in a relational database;
operating an indexing module and an outflow engine on a second side of the de-coupling boundary to transform the anchors into a search index asynchronously from operation of the web integration service; and
operating the outflow engine on the second side of the de-coupling boundary asynchronously from the web integration service to filter outputs of the search index without signaling across the de-coupling boundary.

12. The method of claim 11, further comprising:
the web integration service operating a hot connection module on disparate computer server systems based on cadence rules for connection to and data transfer from each of the disparate computer server systems.

13. The method of claim 12, further comprising:
the hot connection module executing a connection cadence for each of the disparate computer server systems.

14. The method of claim 12, the connection cadence responsive to:
control settings for availability restriction for establishing hot connections;
timing restrictions for opening the hot connections; and
timing restrictions for maintaining the hot connections.

15. The method of claim 11, further comprising:
the normalizing module executing a plurality of data transformation algorithms to transforms output of the web integration service into the relational database.

16. The method of claim 11, further comprising:
the outflow engine applying hierarchical filters on the outputs of the search index independently of generation of the search index by the indexing module.

17. The method of claim 11, further comprising:
the outflow engine applying filter settings to the outputs of the search index without signaling across the de-coupling boundary.

18. The method of claim 11, wherein the web integration service and the outflow engine are serverless.

19. The method of claim 11, further comprising:
generating push notifications from the first side of the de-coupling boundary to the second side of the de-coupling boundary upon completion of operation of the normalizing module.

20. The method of claim 19, further comprising:
the indexing module responding to the push notification by updating the search index based on the anchor tags.
